(19) United States
(12) Patent Application Publication
(10) Pub. No.: US 2026/0219412 A1
(43) Pub. Date: Jul. 30, 2026

(54) ELECTRONIC OBJECT INSIDE WASHING MACHINE DRUM DETECTION SYSTEM

(71) Applicant: Microchip Technology Incorporated, Chandler, AZ (US)

(72) Inventors: Tik Man Lee, Chandler, AZ (US); Edward Raymond Paprocki, Casa Grande, AZ (US); Andy Wah Lam, Gilbert, AZ (US)

(21) Appl. No.: 19/418,914

(22) Filed: Dec. 12, 2025

Related U.S. Application Data
(60) Provisional application No. 63/750,230, filed on Jan. 27, 2025.

(51) Int. Cl. G01V 3/10; D06F 34/05; D06F 34/14; D06F 34/28; D06F 103/00; D06F 105/58

(52) U.S. Cl. CPC G01V 3/10; D06F 34/05; D06F 34/14; D06F 34/28; D06F 2103/00; D06F 2105/58

(57) ABSTRACT

A system and method for detecting electronic objects in a washing machine are provided. The system may include a washing machine drum to hold laundry items, a metal detector sensor positioned to monitor objects entering the drum, a decision-making circuit to process signals from the metal detector sensor and identify electronic objects based on detected electromagnetic characteristics, and an alert circuit to notify a user upon detection of an electronic object.

### CROSS-REFERENCE TO RELATED APPLICATION

The present application claims priority from U.S. Provisional Patent Application

No. 63/750,230, filed on Jan. 27, 2025, which is incorporated herein by reference in its entirety.

### TECHNICAL FIELD

The present disclosure relates generally to washing machine technology, and more specifically to systems and methods for detecting electronic objects inside a washing machine drum using metal detection and artificial intelligence.

### SUMMARY

According to an aspect of one or more examples, there is provided a washing machine system for detecting electronic objects. The system may include a washing machine drum to hold laundry items, a metal detector sensor positioned to monitor objects entering the drum, a decision-making circuit to process signals from the metal detector sensor and identify electronic objects based on detected electromagnetic characteristics, and an alert circuit to notify a user upon detection of an electronic object. The metal detector sensor may utilize electromagnetic induction to detect non-ferrous metals. The system may include an artificial intelligence module to analyze patterns in the sensor output and classify detected objects. The artificial intelligence module may be trained to distinguish between metallic components of electronic devices and non-metallic objects. The artificial intelligence module may be connected to a cloud-based network for updates and enhanced detection capabilities. The alert circuit may provide a visual, auditory, or mobile notification to the user. The drum may be made of a non-metallic material to enhance sensitivity of the metal detector sensor. The system may include a memory module to store detection data for analysis and pattern recognition. The decision-making circuit may include a threshold detection algorithm to determine whether an object is likely an electronic device. The system may include an Internet of Things (IoT) module to integrate the washing machine system with a home automation network.

According to an aspect of one or more examples, there is provided a method for detecting electronic objects in a washing machine. The method may include generating an electromagnetic field at an entry of a washing machine drum, monitoring variations in the electromagnetic field using a metal detector sensor, processing the sensor signals to detect the presence of metallic components of electronic objects, and triggering an alert circuit to notify a user upon detection. The method may include analyzing the sensor signals using an artificial intelligence module to classify detected objects. Analyzing the sensor signals may include identifying patterns associated with electronic devices. The artificial intelligence module may distinguish between metallic and non-metallic objects based on learned signal patterns. The method may include storing detection data for training and improving the artificial intelligence module. Triggering an alert circuit may include sending a notification to a user's mobile device. The method may include adjusting sensitivity of the metal detector sensor based on a size of the detected object. The method may include connecting the washing machine system to an Internet of Things (IoT) network for remote monitoring and control. The method may include configuring the washing machine drum with a non-metallic material to enhance detection sensitivity. The step of monitoring variations in the electromagnetic field may include detecting both ferrous and non-ferrous metals.

### BRIEF DESCRIPTION OF DRAWINGS

FIG. 1 shows an elevation view of a washing machine system for detecting electronic objects according to various examples.

FIG. 2 shows a front view of a washing machine system according to FIG. 1.

FIG. 3A shows a graphical representation of a metal detector sensor output envelope when a washing machine drum is empty according to FIG. 1.

FIG. 3B shows a graphical representation of a metal detector sensor output envelope when a metallic object is detected in a washing machine drum according to FIG. 1.

FIG. 4 shows a flow chart of a method for detecting electronic objects in a washing machine according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

The efficient and safe operation of washing machines is a key concern for both consumers and manufacturers. Modern washing machines are increasingly incorporating advanced technologies to enhance performance, minimize resource usage, and improve user experience. However, accidental damage to washing machine components and personal items during a wash cycle remains an issue. A common problem arises when electronic devices, such as Bluetooth earbuds, are unintentionally left in clothing pockets and subjected to the washing process. This not only leads to the destruction of the electronic devices but also risks damaging the washing machine drum and other components.

Traditional washing machines lack the capability to detect and alert users about the presence of such electronic objects before the washing cycle begins. While some washing machines utilize basic sensors for load detection or imbalance correction, they do not address the specific challenge of identifying electronic devices composed of non-ferrous metals or other components within the drum. Therefore, there exists a need for an improved solution that can detect electronic devices or other abnormal materials inside a washing machine drum to prevent damage, reduce waste, and enhance the overall user experience.

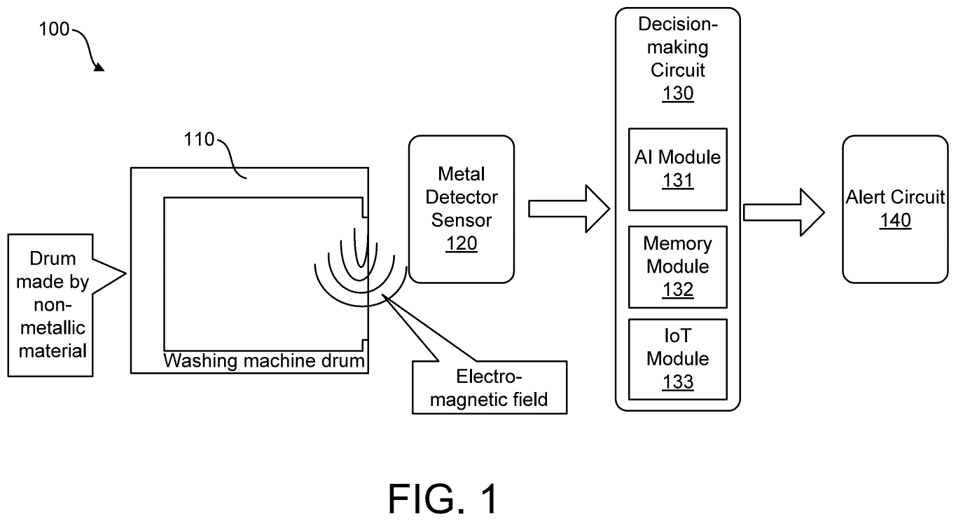

FIG. 1 shows an elevation view of a washing machine system 100 for detecting electronic objects according to various examples. The washing machine system 100 may prevent accidental damage to electronic devices, as well as the washing machine drum 110, by identifying the presence of such objects before the wash cycle. As shown in FIG. 1, the washing machine system 100 may include a washing machine drum 110, a metal detector sensor 120, a decision-making circuit 130, and an alert circuit 140.

The washing machine drum 110 may be designed to hold laundry items and be made of a non-metallic material. This material choice may minimize interference with the electromagnetic field generated by the metal detector sensor 120, ensuring higher sensitivity in detecting metallic objects.

The metal detector sensor 120 may be positioned near the entry of the washing machine drum 110. Additionally or alternatively, the metal detector sensor 120 may be positioned outside the washing machine drum 110. The metal detector sensor 120 may generate an electromagnetic field that interacts with objects entering the washing machine drum 110. When a metallic object, such as components from an electronic device, enters or resides within this electromagnetic field, the metal detector sensor 120 may detect variations and generate a corresponding output signal. According to various examples, the metal detector sensor 120 may be coupled to a power supply for the washing machine system 100. The metal detector sensor 120 may be configured to receive power from the power supply, and begin generating the electromagnetic field, in response to the user opening a door to the washing machine drum 110. According to various examples, the metal detector sensors 120 may conserve power by not generating the electromagnetic field until the door to the washing machine drum 110 is opened. Similarly, when the door to the washing machine drum 110 is closed, the power supply may stop providing power to the metal detector sensors 120.

The decision-making circuit 130 may receive the signal from the metal detector sensor 120 and process the signal to determine whether a metallic object is present. The decision-making circuit 130 may analyze the metal detector sensor 120 output by comparing it against baseline patterns to identify deviations indicative of metallic objects. The decision-making circuit 130 may further compare the metal detector sensor 120 output to user-defined envelope patterns to identify specific objects, such as a particular electronic device. The washing machine system 100 may allow users to train an artificial intelligence model to recognize specific objects by inputting patterns associated with those objects. Additionally or alternatively, the washing machine system 100 may come preloaded with artificial intelligence models designed to identify common metallic objects or electronic devices. Manually trained patterns may be uploaded to a cloud-based platform or server, enabling collective artificial intelligence model refinement and subsequent sharing with other washing machine system 100 users.

Upon confirming the detection of a metallic object, the decision-making circuit 130 may trigger the alert circuit 140 to notify the user. The alert circuit 140 may generate a primary alarm when any metallic object is detected or when a deviation from baseline patterns is observed. Additionally, the alert circuit 140 may generate secondary, object-specific alarms when detecting items it has been trained to recognize, such as a phone or a key fob. Users may configure these alarms to differentiate between objects, allowing for unique alerts tailored to specific devices. The alert may take the form of a visual indication, an audible alarm, or a notification sent to a connected device in a smart home environment, without limitation. In response to the detection of a metallic object or electronic device, the washing cycle may be automatically disabled to prevent potential damage. The washing cycle may be re-enabled through a user override, providing an additional layer of safety and control. This customization may provide users with enhanced flexibility and ensure prompt identification of detected objects.

The washing machine system 100 may operate through the following sequential processes. The metal detector sensor 120 may generate an electromagnetic field at or within the washing machine drum 110. This field may serve as the primary detection medium for identifying metallic objects. As objects enter or remain within the washing machine drum 110, the metal detector sensor 120 may monitor changes in the electromagnetic field. These changes may be indicative of the presence of metallic components. The decision-making circuit 130 may process the signals received from the metal detector sensor 120. By applying algorithms or pattern recognition techniques, the decision-making circuit 130 may determine whether the detected object is likely an electronic device. If the washing machine system 100 identifies an electronic object, the decision-making circuit 130 may trigger the alert circuit 140 to notify the user. The washing cycle may be automatically disabled to prevent potential damage. The washing cycle may be resumed by a deliberate action taken by the user, ensuring that any detected objects have been addressed. This sequence may allow the user to inspect the laundry for any electronic devices or metallic objects before resuming operation, thereby protecting both the washing machine and its contents.

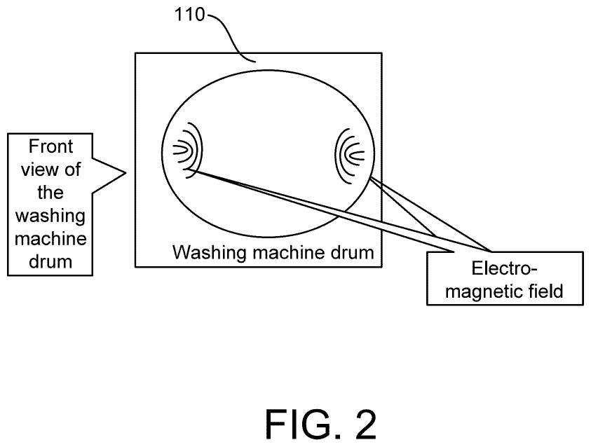

FIG. 2 shows a front view of the washing machine system 100 according to FIG. 1. The washing machine drum 110 may be a component of the washing machine system 100, designed to hold laundry items during operation. The washing machine drum 110 may be constructed from a non-metallic material to improve the functionality of the metal detector sensor 120. By utilizing a non-metallic material, the washing machine system 100 may reduce interference with the electromagnetic field generated by the metal detector sensor 120, allowing for enhanced sensitivity and accuracy in detecting metallic objects. The non-metallic construction may ensure that the washing machine drum 110 itself does not affect the detection process, thereby providing a clear environment for monitoring objects entering the washing machine drum 110.

The metal detector sensor 120 may be positioned at the entry point of the washing machine drum 110 and operate by generating an electromagnetic field. This field may serve as a detection medium, identifying changes caused by the presence of metallic objects as they pass through the field. The metal detector sensor 120 may be capable of detecting metallic components commonly found in electronic devices, such as battery terminals or casings. When a metallic object, such as an electronic device, enters the electromagnetic field, the metal detector sensor 120 may detect the resulting variation and generate a signal corresponding to the detected object.

As shown in FIG. 2, the electromagnetic field may be oriented to monitor the entry of objects into the washing machine drum 110. This arrangement may ensure that metallic objects are identified before they are subjected to the washing cycle, providing an opportunity to alert the user to their presence. The washing machine system's 100 sensitivity may be such that it can detect non-ferrous metals, including those used in electronic devices, ensuring comprehensive detection capabilities. This combination of a non-metallic washing machine drum 110 and a strategically placed metal detector sensor 120 may represent an advancement in washing machine technology, enhancing both safety and user convenience.

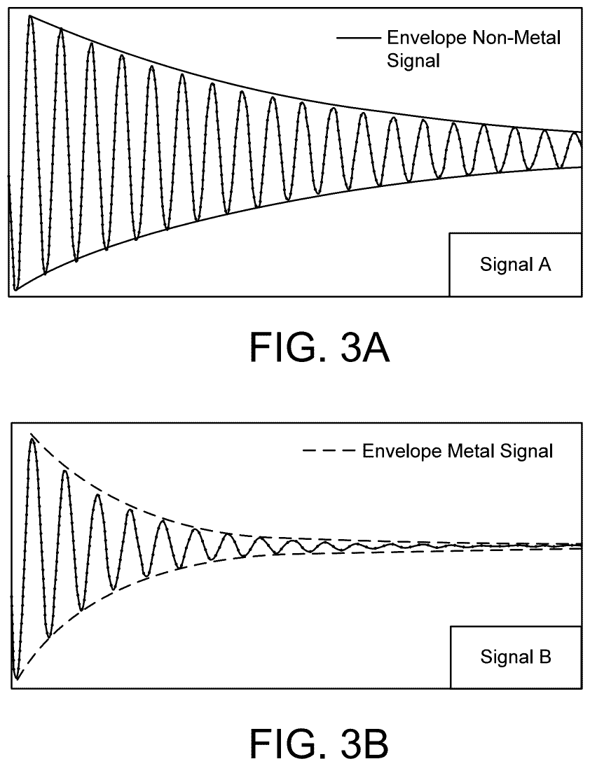

FIG. 3A shows a graphical representation of the metal detector sensor 120 output envelope when the washing machine drum 110 is empty according to FIG. 1. The graph, labeled Signal A, may represent the metal detector sensor 120 output when the washing machine drum 110 is empty. In this state, the metal detector sensor 120 may produce an envelope for a non-metal signal, characterized by a smooth decay pattern over time. The signal may maintain a consistent and uniform shape, indicating no significant interaction with metallic objects within the electromagnetic field. This envelope may serve as a baseline for the washing machine system 100, representing the absence of any abnormal metallic components in the washing machine drum 110.

FIG. 3B shows a graphical representation of the metal detector sensor 120 output envelope when a metallic object is detected in the washing machine drum 110 according to FIG. 1. The graph, labeled Signal B, may depict the metal detector sensor 120 output when a metallic object is present in the washing machine drum 110. The envelope for this metal signal may display distinct variations compared to the non-metal signal in FIG. 3A. These variations may include a disruption in the smooth decay pattern and higher amplitude oscillations, which may be indicative of the metal detector sensor 120 detecting metallic components within the electromagnetic field. The sharp deviation from the baseline pattern may enable the washing machine system 100 to identify the presence of a metallic object, triggering further processing to determine the type of object.

The washing machine system 100 may leverage an AI module 131 to analyze these metal detector sensor 120 outputs and distinguish between electronic products and non-electronic products. By comparing the detected envelope (e.g., Signal B) to the baseline (e.g., Signal A), the AI module 131 may identify the abnormal pattern associated with metallic objects. This capability may ensure accurate detection and classification, enabling the washing machine system 100 to notify the user of potential hazards, such as electronic devices left inside the washing machine drum 110. The AI module 131 may analyze patterns in the metal detector sensor 120 output and classify detected objects. The AI module 131 may be trained to distinguish between metallic components of electronic devices and non-metallic objects. The AI module 131 may be connected to a cloud-based network for updates and enhanced detection capabilities. The AI module 131 may be contained within the decision-making circuit 130, as shown in FIG. 1, or may be separate from the decision-making circuit 130. The decision-making circuit 130 may also include a memory module 132 to store detection data for analysis and pattern recognition, and an Internet of Things (IoT) module 133 to integrate the washing machine system 100 within a home automation network. For example, the IoT module 133 may be configured to communicate with a local area network such as a Wi-Fi network, and may enable remote monitoring and control of the washing machine system 100. The memory module 132 and IoT module 133 may be contained within the decision-making circuit 130, as shown in FIG. 1, or may be separate from the decision-making circuit 130.

The graphs, labeled Signal A and Signal B in FIGS. 3A and 3B, respectively, may demonstrate the effectiveness of the washing machine system 100 in recognizing metallic objects based on distinct signal patterns, providing a reliable solution for preventing damage to both the washing machine and the items being washed. The described technology may represent a significant advancement in the integration of sensor technology and AI for household appliances.

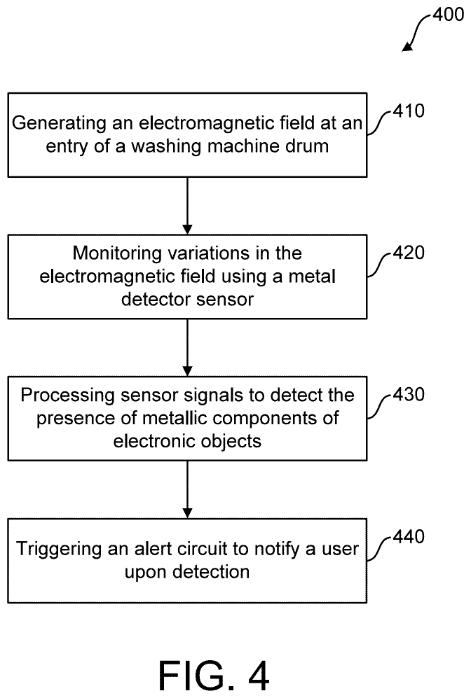

FIG. 4 shows a flow chart of a method 400 for detecting electronic objects in a washing machine according to various examples. At operation 410, the method 400 may include generating an electromagnetic field at an entry of a washing machine drum, which may be done by metal detector sensor 120 of FIG. 1, for example. At operation 420, the method 400 may include monitoring variations in the electromagnetic field using a metal detector sensor, such as the metal detector sensor 120 of FIG. 1, however the generation of the electromagnetic field and monitoring of variations in the electromagnetic field may be performed by different components according to various examples. At operation 430, the method 400 may include processing sensor signals to detect the presence of metallic components of electronic objects, which may be performed by decision-making circuit 130 of FIG. 1, for example. At operation 440, the method 400 may include triggering an alert circuitry, such as alert circuit 140 of FIG. 1, to notify a user upon detection of an electronic object. The triggering at operation 440 may be performed by decision-making circuit 130, for example.

Various examples have been disclosed herein, in connection with the above description and the drawings. It will be understood that it would be unduly repetitious to literally describe and illustrate every combination and subcombination of these examples. Accordingly, all examples can be combined in any way or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A washing machine system for detecting electronic objects, comprising:
a washing machine drum to hold laundry items;
a metal detector sensor positioned to monitor objects entering the drum;
a decision-making circuit to process signals from the metal detector sensor and identify electronic objects based on detected electromagnetic characteristics; and
an alert circuit to notify a user upon detection of an electronic object.

2. The system of claim 1, wherein the metal detector sensor utilizes electromagnetic induction to detect non-ferrous metals.

3. The system of claim 1, further comprising an artificial intelligence module to analyze patterns in the metal detector sensor output and classify detected objects.

4. The system of claim 3, wherein the artificial intelligence module is trained to distinguish between metallic components of electronic devices and non-metallic objects.

5. The system of claim 3, wherein the artificial intelligence module is connected to a cloud-based network for updates and enhanced detection capabilities.

6. The system of claim 1, wherein the alert circuit is to provide a visual, auditory, or mobile notification to the user.

7. The system of claim 1, wherein at least a portion of the drum is made of a non-metallic material to enhance sensitivity of the metal detector sensor.

8. The system of claim 1, further comprising a memory module to store detection data for analysis and pattern recognition.

9. The system of claim 1, wherein the decision-making circuit includes a threshold detection algorithm to determine whether an object is likely an electronic device.

10. The system of claim 1, further comprising an Internet of Things (IoT) module to integrate the washing machine system with a home automation network.

11. A method for detecting electronic objects in a washing machine, comprising:
generating an electromagnetic field at an entry of a washing machine drum;
monitoring variations in the electromagnetic field using a metal detector sensor;
processing the sensor signals to detect presence of metallic components; and
triggering an alert circuit to notify a user upon detection.

12. The method of claim 11, further comprising analyzing the sensor signals using an artificial intelligence module to classify detected objects.

13. The method of claim 12, wherein analyzing the sensor signals includes identifying patterns associated with electronic devices.

14. The method of claim 12, wherein the artificial intelligence module distinguishes between metallic and non-metallic objects based on learned signal patterns.

15. The method of claim 12, further comprising storing detection data for training and improving the artificial intelligence module.

16. The method of claim 11, wherein triggering an alert circuit includes sending a notification to a user's mobile device.

17. The method of claim 11, further comprising adjusting sensitivity of the metal detector sensor based on a size of the detected object.

18. The method of claim 11, further comprising connecting the washing machine system to an Internet of Things (IoT) network for remote monitoring and control.

19. A system for detecting electronic objects in a washing machine, the system comprising:
a metal detector sensor positioned to generate an electromagnetic field to monitor objects entering the washing machine;
a decision-making circuit to process signals from the metal detector sensor and identify objects based on detected electromagnetic characteristics; and
an alert circuit to notify a user upon detection of an object.

20. The system of claim 19, comprising an artificial intelligence module to perform at least one of: analyzing patterns in the metal detector sensor output, classifying detected objects, and distinguishing between metallic objects and non-metallic objects.
